(19) United States
(12) Patent Application Publication
(10) Pub. No.: US 2002/0165057 A1
(43) Pub. Date: Nov. 7, 2002

(54) High strength roller chain

(76) Inventors: Robert N. Barton, Indianapolis, IN (US); John A. Wright, Carmel, IN (US)

Correspondence Address: Edward J. Brosius, AMSTED Industries Incorporated, 44th Floor, 205 North Michigan Avenue, Chicago, IL, 60601, US

(21) Appl. No.: 09/848,661

(22) Filed: May 4, 2001

(51) Int. Cl. F16G 13/02

(52) U.S. Cl. 474/231; 474/230; 474/228

(57) ABSTRACT

The present invention relates to a high strength roller chain adapted for both high cyclic loads as well as intermittent high shock loads. The roller chain of the present invention includes a pin link plate having a cross sectional area through a center line of a pin receiving aperture greater than a pin link plate in a standard ANSI of an equivalent size roller chain. Further, the cross sectional area of the roller link plate through center line of one of the bushing-receiving openings is greater than that of a roller link plate in a standard ANSI roller link plate in an equivalent size roller chain. Further, the pin itself has a greater cross sectional area than the pin of a standard ANSI equivalent size roller chain.

### BACKGROUND OF THE INVENTION

The present invention relates generally to roller chain and, more particularly, roller chains having high strength giving increased fatigue limits over that of an ANSI standard roller chain of an equivalent size. Chain drives utilizing roller chains in applications such as loaders are subjected to repeated high cyclic loads as well as intermittent high shock loads. These loads can be above the fatigue loads of ANSI standard roller chain and even ANSI heavy duty series roller chain resulting in premature chain failure. Accordingly, a chain having increased fatigue limits and overall greater strength is needed for such applications. However, the chain must able to operate within the contour envelope as a standard ANSI chain of similar size due to space constraints; further, the chain must be able to operate over standard ANSI sprockets for a similar size chain.

Accordingly, it is an object of the present invention to provide an high-strength roller chain that is able to operate within the same size envelope as a standard ANSI chain of similar size.

It is a further object of the present invention to provide a roller chain that is able to operate over standard ANSI sprockets for a standard ANSI roller chain of similar size.

### SUMMARY OF THE INVENTION

Typical roller chain itself is comprised of five major components: pins, bushings, rollers, pin link plates and roller link plates. The assembly of such roller chain requires that each pin extends through an axial pin-receiving opening in a bushing in a free relative rotating manner. Further, each bushing extends through an axial bushing-receiving opening in a roller, again in a free relative rotating manner. Each pin has a pair of ends that extend laterally into a pair of circular pin-receiving openings in a laterally spaced pair of pin link plates. Further, each bushing has two ends that extend into bushing-receiving openings in a pair of laterally spaced roller link plates. The ends of the pins are fitted into the opening in the pin link plates is in a secure fashion such that there is no relative rotation between the pin and the pin link plate. Similarly, each bushing is fitted into the bushing-receiving opening in the roller link plate in a secure manner such that there is no relative rotation between the bushing and the roller link plate.

In a standard ANSI roller chain, the pin link plate is typically of a smaller contour than the roller link plate. In the roller chain of the present invention, the pin link plate is increased in size to the full contour of the roller link plate while reducing the thickness of the pin link plate. The pin itself is also of a larger diameter and cross section to provide increased fatigue strength to the roller chain. An important feature of the present invention is increasing of the cross sectional area of the pin link plate compared to that of a standard ANSI roller chain of equivalent size. Such cross sectional area is defined as the area of a cross section of one of the pin link plates through a center line of one of the pin-receiving openings. Such cross sectional area excludes the area of the pin-receiving opening itself. By increasing the overall contour of the pin link plate, this results in an increased height of the pin link plate. Even though the thickness of the pin link plate is decreased, the overall cross sectional area is increased in an amount about 12 percent greater than a standard ANSI pin link plate in an equivalent size roller chain.

Another important feature of the present invention is an increase in the cross sectional area of the roller link plate. Such cross sectional area is defined as the area of a cross section of one of the roller link plates through a center line of one of the bushing-receiving openings. Such area excludes the area of the bushing-receiving opening itself. Such increasing in area of the roller link plate is typically accomplished by increasing the thickness of the roller link plate such that the cross sectional area is increased to about 17 percent greater than a standard ANSI roller link plate in an equivalent size roller chain.

The combination of the increased cross sectional area of the pin link, the roller link plate and the pin itself result in a high strength roller chain with improved fatigue strength over a standard ANSI roller chain of similar size.

### DETAILED DESCRIPTION OF THE DRAWINGS In the Drawings,

FIG. 1 is a perspective view of a roller chain in accordance with the present invention;

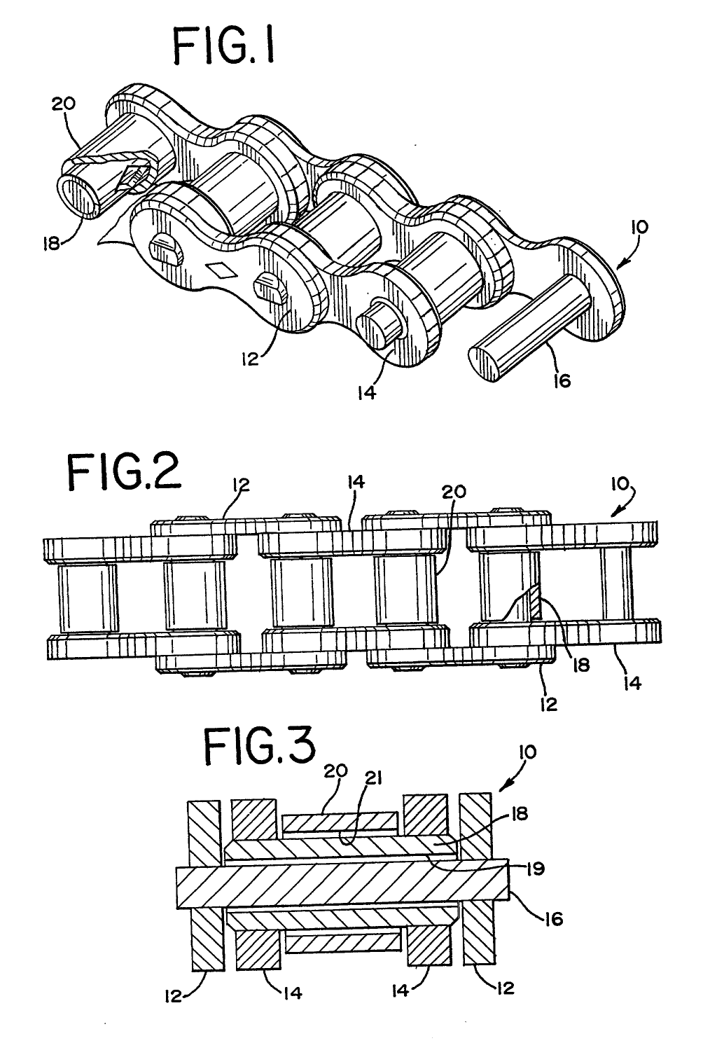

FIG. 2 is a top view of a roller chain in accordance with the present invention;

FIG. 3 is a cross sectional view of a roller chain in accordance with the present invention;

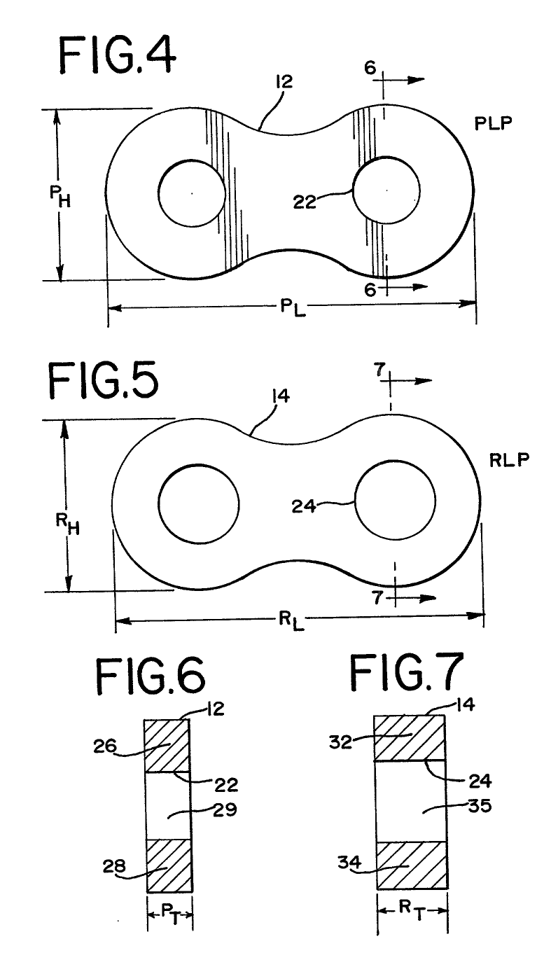

FIG. 4 is a side view of a pin link plate of a roller chain in accordance with the present invention;

FIG. 5 is a side view of a roller link plate in accordance with the present invention;

FIG. 6 is a cross sectional view along line 6-6 of the pin link plate of FIG. 4, and

FIG. 7 is a cross sectional view along line 7-7 of the roller link plate of FIG. 5.

### DETAILED DESCRIPTION OF THE INVENTION

Referring now to FIGS. 1 and 2 of the drawings, a roller chain in accordance with the present invention is shown generally at 10. Such roller chain is seen to comprise pin link plates 12 and roller link plates 14. Such pin link plates 12 and roller link plates 14 are typically stamped steel pieces of a generally flat configuration, with an elongated generally figure eight contour. Pin link plate 12 includes a pair of circular openings 22 shown in FIG. 4. Roller link plate 14 includes a pair of circular openings 24 shown in FIG. 5.

Typical roller chain is seen to be assembled in a manner such that alternating pairs of pin link plates 12 and roller link plates 14 are laterally spaced and longitudinally aligned such that pins 16 extend between and are securely received in openings 22 in pin link plates 12. Each pin 16 as best seen in FIG. 3, extends through an axial opening 19 in elongated cylindrical bushing 18. It should be understood that pin 16 and axial opening 19 in bushing 18 are selected and sized such that bushing 18 is free to rotate relative to pin 16. Pin 16 does not rotate relative to pin link plate 12.

The secure fitting of pin 16 in pin-receiving openings 22 in pin link plate 12 is accomplished in a press fit operation. Similarly, bushings 18 are securely press in fit bushing-receiving openings 24 in roller link plates 14. Such securing is accomplished in a press fit operation such that bushing 18 does not rotate relative to roller link plate 14. Bushings 18 are typically a closed metal cylinder, usually comprised of steel.

Lastly, rollers 20 are seen to be comprised of a generally cylindrical metal, usually steel, structure having an axial bushing-receiving opening 21. Bushing 18 is received in bushing-receiving opening 21 with appropriate relative sizing allowing roller 22 to rotate freely about bushing 18.

Referring now to FIG. 3, it is seen that roller link plate 14 is of a thicker cross section than pin link plate 12. In fact, pin link plate 12 is of a lesser thickness than a pin link plate in a standard ANSI roller chain of equivalent size. Further, roller link plate 14 is thicker than a standard ANSI chain of equivalent size. Such thickness increase is typically about 8 percent.

Referring now to FIGS. 4-7, the cross sectional area of pin link plate 12 is seen to comprise the sum of areas 26 and 28. The overall contour of pin link plate 12 relates to the length PL times the height PH. It is usual in the high strength roller chain of the present invention for the contour of pin link plate 12 to be nearly equal or equal to the contour of roller link plate 14, which itself is understood to be the length RL times the height RH of roller link plate 14.

The cross sectional area of pin link plate 12 is defined as the cross sectional area along the center line for FIG. 6-6 through the center line of pin opening 22. This is best seen in FIG. 6 as the sum of areas 26 and 28, which would typically be the height PH of pin link plate 12 times the thickness PT of pin link plate 12, less the area of pin opening 22 in cross sectional configuration along line 6-6 as shown as 29 in FIG. 6. The cross sectional area of pin link plate 12 is understood to be 12 percent greater than that of a pin link plate in an ANSI standard chain of equivalent size.

Referring now to FIGS. 5 and 7, roller link plate 14 is seen to be of a contour of length RL times height RH. Referring to line 7-7 through a center line of bushing-receiving 24, cross sectional area of roller link plate 14 is defined as the sum of areas 32 and 34. Such cross sectional area is seen to be the height RH of roller link plate 14 times the thickness RT, less the cross sectional area of bushing-receiving opening 24 shown as 35 in FIG. 7. It is understood that the cross sectional area of roller link plate 14 is 17 percent greater than the cross sectional area of a roller link plate in an ANSI standard roller chain of equivalent size.

It should also be understood that pin 16 itself is of a cross sectional area of 11 percent greater than a pin in an ANSI standard chain of equivalent size.

The overall tensile strength of a roller chain of the present invention is about 30% greater than that of an ANSI standard roller chain of an equivalent size.

What is claimed is:

1. A roller chain comprising
a plurality of pin link plates, each of said pin link plates having a first and a second circular pin-receiving aperture,
a plurality of roller link plates, each of said roller link plates having a first and a second circular bushing-receiving aperture,
a plurality of generally cylindrical elongated pins,
a plurality of generally cylindrical elongated bushings each having an axial pin-receiving opening,
said roller chain being assembled such that each of said pins extends through said axial pin receiving opening in one of said bushings in a free rotating manner and each of said bushings in turn extends through said axial bushing-receiving opening in one of said rollers in a free rotating manner, said roller chain further being assembled such that each of said pins has a pair of ends extending through one of said circular bushing-receiving apertures in a pair of longitudinally aligned and laterally spaced roller link plates, with each of said ends of said pins being securely fitted within one of said pin receiving apertures in a pair of longitudinally aligned and laterally spaced pin link plates,
said roller chain further being assembled such that each of said bushings has a pair of ends each of which is securely fitted within one of said bushing-receiving apertures in a pair of longitudinally aligned and laterally spaced bushing link plates,
said roller chain further being assembled such that each of said bushings extends through one of said axial bushing-receiving openings in one of said rollers such that said roller is free to rotate with respect to said bushing,
said roller chain further being assembled such that each of said pins extends through one of said axial pin-receiving openings in one of said bushings such that said pin is free to rotate with respect to said bushings,
wherein a cross sectional area of said pin link plate is defined as the area of a cross section of one of said pin link plates vertically cut through a center line of one of said first or second pin-receiving apertures excluding the area of said pin-receiving aperture and wherein by increasing said pin link plate in height such that said cross sectional area of said pin link plate is about 12 percent greater than a standard ANSI pin link plate of an equivalent size roller chain,
and wherein a cross sectional area of said roller link plate is defined as the area of a cross section of one of said roller link plates vertically cut through a center line of one of said first or second bushing-receiving apertures excluding the area of said bushing-receiving aperture and wherein by increasing said roller link plate in thickness such that said cross sectional area of said roller link plate is about 17 percent greater than a standard ANSI roller link plate of an equivalent size roller chain.

2. The roller chain of claim 1
wherein each of said pins is of a cross sectional area of about 12 percent greater than a standard ANSI pin of an equivalent size roller chain.

3. The roller chain of claim 1
wherein each of said pin link plates is of a thickness less than that of a standard ANSI pin link plate of an equivalent size roller chain.

4. The roller chain of claim 1
wherein the tensile strength of the roller chain is about 30% greater than the tensile strength of standard ANSI roller chain of an equivalent size.

5. The roller chain of claim 1
wherein the roller chain is of standard outside dimensions for an ANSI roller chain of an equivalent size.

6. The roller chain of claim 1
wherein each of said roller link plates is of a thickness greater than that of a standard ANSI roller link plate of an equivalent size roller chain.

7. The roller chain of claim 1
wherein a standard ANSI 100 H chain has a cross sectional area of a pin link plate of about 0.111 square inch and the cross sectional area of said pin link plate of said roller chain of an equivalent ANSI size is about 0.124 square inch.

8. The roller chain of claim 1
wherein a standard ANSI 100 H chain has a cross sectional area of a roller link plate of about 0.111 square inch and the cross sectional area of said roller link plate of said roller chain of an equivalent ANSI size is about 0.130 square inch.

9. The roller chain of claim 1
wherein a standard ANSI 100 H chain has a cross sectional area of a pin of about 0.110 square inch and the cross sectional area of said pin of said roller chain of an equivalent ANSI size is about 0.123 square inch.

10. A method of increasing the tensile strength of an ANSI standard roller chain
comprising increasing the cross sectional area of each pin link plate to about 12 percent greater than the cross sectional area of a standard ANSI pin link plate of an equivalent size roller chain,
and increasing the cross sectional area of each roller link plate to about 17 percent greater than the cross sectional area of a standard ANSI roller link plate of an equivalent size roller chain
while keeping the outside dimensions of said roller chain to those of a standard ANSI roller chain of an equivalent size.

11. The method of claim 10
further comprising increasing the cross sectional area of each pin to about 12 percent greater than the cross sectional area of a standard ANSI pin of an equivalent size roller chain.

12. The method of claim 10
further comprising reducing the thickness of each of said pin link plates to less than that of a standard ANSI pin link plate of an equivalent size roller chain.

13. The method of claim 10
further comprising increasing the thickness of each of said roller link plates to greater than that of a standard ANSI roller link plate of an equivalent size roller chain.
